(19) United States
(12) Patent Application Publication
(10) Pub. No.: US 2025/0015879 A1
(43) Pub. Date: Jan. 9, 2025

(54) Systems and Methods for Satellite Messaging

(71) Applicant: Google LLC, Mountain Viewe, CA (US)

(72) Inventors: Dang Tu Nguyen, San Diego, CA (US); Sooraj Sasindran, San Diego, CA (US); Aishwarya Mallampati, Gilroy, CA (US); Sarah Elizabeth Kim, San Jose, CA (US)

(21) Appl. No.: 18/218,355

(22) Filed: Jul. 5, 2023

(51) Int. Cl. H04B 7/185; H04W 4/14

(52) U.S. Cl. CPC H04B 7/18513; H04W 4/14

(57) ABSTRACT

A computer-implemented method is provided. The method includes enabling, by a mobile device, reception of satellite-communicated datagrams. The method also includes receiving, by the mobile device, a satellite datagram from a satellite after enabling reception of satellite-communicated datagrams. Transmission of the satellite datagram is initiated from a nearby mobile device within a region of interest of the mobile device. The method also includes displaying, by the mobile device, a notification based on the satellite datagram.

### BACKGROUND

In emergency situations, mobile devices can be used to provide alerts to remote parties. To illustrate, if a driver gets into a car accident, the driver can use cellular services associated with a mobile device (e.g., a mobile phone) to call emergency services for assistance. As a non-limiting example, the driver can dial “911” and request that an ambulance come to the scene of the accident. In scenarios where the driver has not suffered injuries that warrant emergency services, the driver can use the cellular services associated with the mobile device to call friends, family, roadside assistance, etc.

However, in some scenarios, the driver may not be able to use the cellular services associated with the mobile device to call emergency services or alert nearby parties. As a non-limiting example, if the driver gets into a car accident in an area where there is no cellular coverage, or limited cellular coverage, the driver may not be able to use the cellular services associated with the mobile device to alert emergency services or nearby parties. In particular, the driver may not be able to dial “911” for emergency assistance because there is no cellular service.

### SUMMARY

A first mobile device can utilize satellites to broadcast satellite messages to nearby mobile devices. To illustrate, a user of the first mobile device can generate a satellite datagram that includes a text message, location-sharing information, or both. After generating the satellite datagram, the first mobile device can initiate the broadcast of the satellite datagram by transmitting the satellite datagram to a satellite. The satellite can relay the satellite datagram to a gateway device. The gateway device can identify nearby mobile devices that have enabled reception of satellite-based communications, such as satellite datagrams. For example, users of nearby mobile devices can select an option on a user interface to enable reception of satellite-based communications. If a particular user of a particular nearby mobile device selects the option to enable reception of satellite-based communications, an identifier of the particular nearby mobile device can be included in a list that is provided to the gateway device. The gateway device can forward the satellite datagram, from the satellite, to each nearby mobile device on the list.

Upon receiving the satellite datagram from the gateway device, a notification can be displayed at the particular nearby mobile device. The notification is based on the satellite datagram. For example, the notification can include the text message, the location-sharing information, or both. In some embodiments, the particular nearby mobile device can fetch a source address of the first mobile device from the satellite datagram and use the source address to communicate with the first mobile device through the satellite. Thus, in scenarios where the first mobile device is in an area where there is no cellular coverage, the first mobile device can communicate with nearby mobile devices via the satellite.

In one aspect, a computer-implemented method is provided. The method includes enabling, by a mobile device, reception of satellite-communicated datagrams. The method also includes receiving, by the mobile device, a satellite datagram from a satellite after enabling reception of satellite-communicated datagrams. Transmission of the satellite datagram is initiated from a nearby mobile device within a region of interest of the mobile device. The method also includes displaying, by the mobile device, a notification based on the satellite datagram.

In another aspect, a mobile device includes a memory and a processor coupled to the memory. The processor is configured to enable reception of satellite-communicated datagrams. The processor is also configured to receive a satellite datagram from a satellite after enabling reception of satellite-communicated datagrams. Transmission of the satellite datagram is initiated from a nearby mobile device within a region of interest of the mobile device. The processor is further configured to display a notification based on the satellite datagram.

In another aspect, a non-transitory computer-readable medium includes instructions that, when executed by a processor of a mobile device, cause the processor to enable reception of satellite-communicated datagrams. The instructions, when executed by the processor, further cause the processor to receive a satellite datagram from a satellite after enabling reception of satellite-communicated datagrams. Transmission of the satellite datagram is initiated from a nearby mobile device within a region of interest of the mobile device. The instructions, when executed by the processor, further cause the processor to display a notification based on the satellite datagram.

In another aspect, a computer-implemented method is provided. The method includes generating, by a mobile device, a satellite datagram. The method also includes initiating, by the mobile device, a broadcast of the satellite datagram to nearby mobile devices within a region of interest of the mobile device. Initiating the broadcast of the satellite datagram includes transmitting the satellite datagram to a satellite, and the broadcast causes a display of a notification on at least one nearby mobile device. The notification is associated with the satellite datagram.

In another aspect, a mobile device includes a memory and a processor coupled to the memory. The processor is configured to generate a satellite datagram. The processor is also configured to initiate a broadcast of the satellite datagram to nearby mobile devices within a region of interest of the mobile device. Initiating the broadcast of the satellite datagram includes transmitting the satellite datagram to a satellite, and the broadcast causes a display of a notification on at least one nearby mobile device. The notification is associated with the satellite datagram.

In another aspect, a non-transitory computer-readable medium includes instructions that, when executed by a processor of a mobile device, cause the processor to generate a satellite datagram. The processor is also configured to initiate a broadcast of the satellite datagram to nearby mobile devices within a region of interest of the mobile device. Initiating the broadcast of the satellite datagram includes transmitting the satellite datagram to a satellite, and the broadcast causes a display of a notification on at least one nearby mobile device. The notification is associated with the satellite datagram.

In another aspect, a computer-implemented method is provided. The method includes receiving, by a gateway device, a list of nearby mobile devices that have selected an option to enable reception of satellite-communicated datagrams. The method also includes receiving, by the gateway device and from a satellite, a satellite datagram generated by a mobile device. The method also includes causing a notification to be displayed on each mobile device in the list of nearby mobile devices. The notification is associated with the satellite datagram.

In another aspect, a gateway device includes a memory and a processor coupled to the memory. The processor is configured to receive a list of nearby mobile devices that have selected an option to enable reception of satellite-communicated datagrams. The processor is also configured to receive, from a satellite, a satellite datagram generated by a mobile device. The processor is also configured to cause a notification to be displayed on each mobile device in the list of nearby mobile devices. The notification is associated with the satellite datagram.

In another aspect, a non-transitory computer-readable medium includes instructions that, when executed by a processor of a gateway device, cause the processor to receive a list of nearby mobile devices that have selected an option to enable reception of satellite-communicated datagrams. The instructions, when executed by the processor, further cause the processor to receive, from a satellite, a satellite datagram generated by a mobile device. The instructions, when executed by the processor, further cause the processor to cause a notification to be displayed on each mobile device in the list of nearby mobile devices. The notification is associated with the satellite datagram.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates a system that enables a mobile device to communicate with other nearby mobile devices using satellite messaging, in accordance with example embodiments.

FIG. 2 illustrates a first portion of a process for broadcasting satellite datagrams to nearby mobile devices using satellite messaging, in accordance with example embodiments.

FIG. 3 illustrates a second portion of the process for broadcasting satellite datagrams to nearby mobile devices using satellite messaging, in accordance with example embodiments.

FIG. 4 illustrates a device configuration for a mobile device that can broadcast satellite datagrams, in accordance with example embodiments.

FIG. 5 illustrates a mobile device that is operable to broadcast satellite messages to nearby mobile devices and operable to receive broadcast satellite messages from nearby mobile devices, in accordance with example embodiments.

FIG. 6 illustrates a gateway device that is operable to forward broadcast satellite datagrams to nearby devices, in accordance with example embodiments.

FIG. 7 is a flowchart of a method, in accordance with example embodiments.

FIG. 8 is a flowchart of another method, in accordance with example embodiments.

FIG. 9 is a flowchart of another method, in accordance with example embodiments.

### DETAILED DESCRIPTION

### Overview

The techniques described herein enables a mobile device to broadcast satellite messages to nearby mobile devices and/or receive satellite messages broadcast messages while the mobile device is in an area with limited cellular service. In particular, the techniques described herein enable the mobile device to receive broadcast satellite messages from other mobile devices, broadcast satellite alerting messages from satellite services providers, or broadcast satellite alerting messages from emergency service centers.

By enabling the broadcast and reception of satellite messages, emergency messages and responses to emergency messages can be communicated in areas with limited cellular coverage. As a non-limiting example, if a particular user suffers an accident in an area with limited (or no) cellular coverage, the particular user may not be able to dial “911” to ask for assistance. However, according to the techniques described herein, the particular user can send a satellite message, requesting help, to other nearby mobile device users. Upon reception of the satellite message, the other nearby mobile device users can (1) respond to the particular user (via satellite message), (2) track a location of the particular user, or both, to provide emergency assistance to the particular user. Thus, when the particular user is in a remote area where emergency services cannot respond quickly, the particular user can seek help from other nearby mobile device users via satellite messaging.

To broadcast a satellite message to nearby mobile devices, a user of the mobile device can activate a satellite messaging feature using a user interface. In response to activating the satellite messaging feature, the mobile device can generate a satellite datagram using different applications. For example, the mobile device can use a messaging application to generate a satellite datagram that includes a text message for nearby mobile devices. To illustrate, if the user of the mobile device is stranded in the woods, the user can use the messaging application to generate a text message that states “Help, I am stranded in the woods”. As another example, the mobile device can use a maps application to generate a satellite datagram that includes location-sharing information. The location information can be used by nearby mobile devices to track a location of the mobile device. The mobile device can encode the text message, the location-sharing information, or both, into the satellite datagram.

The mobile device can also populate a broadcast field in a header of the satellite datagram to indicate that the satellite datagram should be broadcast to all nearby mobile devices. Additionally, the mobile device can populate a source address field in the header of the satellite datagram with a source address of the mobile device. Populating the source address field with the source address of the mobile device provides a recipient of the satellite datagram with a mechanism to respond to the satellite datagram over satellite.

The mobile device can transmit the satellite datagram to a satellite, which in turn, can forward the satellite datagram to a satellite gateway. The satellite gateway can forward the satellite datagram to a local/regional gateway device. The local/regional gateway device can obtain a list of other mobile devices (e.g., nearby mobile devices) that have also activated the satellite messaging feature. By activating the satellite messaging feature, users of the nearby mobile devices have consented to receiving satellite messages from other mobile devices, satellite services providers, and emergency service centers. The local/regional gateway device can forward the satellite datagram to each nearby mobile device on the list.

In response to receiving the satellite datagram, a particular nearby mobile device on the list can decode the satellite datagram and a notification associated with the satellite datagram is displayed at the particular nearby mobile device. The notification can include the text message and/or location-sharing information. In some embodiments, the location-sharing information can be used to track the location of the mobile device. Additionally, the particular nearby mobile device can parse the header of the satellite datagram to obtain the source address of the mobile device. Using the source address of the mobile device, the particular nearby mobile device can generate a response satellite datagram (e.g., a text message response) to send to the mobile device via satellite.

Thus, the techniques described herein enables the mobile device to broadcast satellite messages to nearby mobile devices while the mobile device is in an area without cellular coverage. For example, by generating the satellite datagram and broadcasting the satellite datagram to nearby mobile devices using satellite messaging infrastructures (e.g., the satellite, the satellite gateway, and the local/regional gateway device), the mobile device can communicate with nearby mobile devices while the mobile device is in an area without cellular coverage. Thus, in emergency situations, a user of the mobile device can broadcast the satellite datagram (e.g., a text message, a location-sharing message, or both) to nearby mobile devices to request assistance. For example, if the user of the mobile device suffers an injury and cannot reach emergency services due to the lack of cellular services, the user can broadcast the satellite datagram to the nearby mobile devices to request assistance.

With respect to transmitting and receiving satellite messages, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user. Thus, the user may have control over what information is collected about the user, how that information is used, and what information is provided to the user.

It should be appreciated that the above broadcasting techniques can also be performed by emergency service centers and satellite service providers to broadcast satellite alerting messages to nearby mobile devices that have activated the satellite messaging feature.

### Example Satellite Messaging Systems

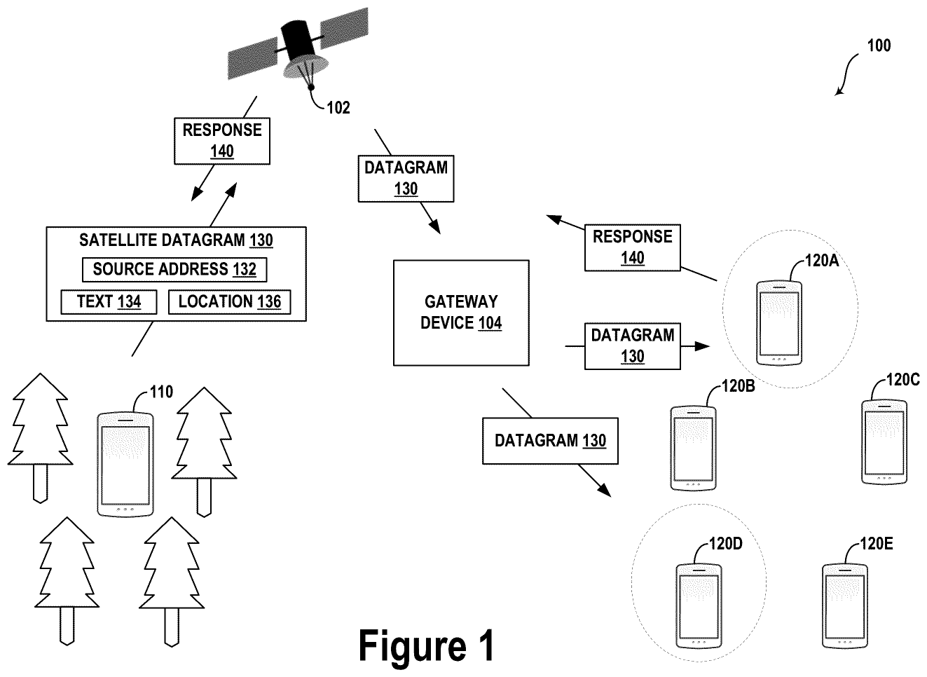

Particular examples are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple mobile devices are illustrated and associated with reference numbers 120A, 120B, 120C, etc. When referring to a particular one of the mobile devices, such as the mobile device 120, the distinguishing letter “A” is used. However, when referring to any arbitrary one of these mobile devices or to these mobile devices as a group, the reference number 120 is used without a distinguishing letter.

FIG. 1 illustrates a system 100 that enables a mobile device to communicate with other nearby mobile devices using satellite messaging. The system 100 includes a satellite 102, a gateway device 104, a mobile device 110, and a plurality of nearby mobile devices 120. As used herein, a “nearby” mobile device can correspond to a mobile device within a transmission range of the satellite 102, a mobile device within a transmission range of the gateway device 104, or a mobile device within a “region of interest” of the mobile device 110. As a non-limiting example, any mobile device within a ten (10) mile radius of the mobile device 110 can be classified as a nearby mobile device. However, it should be understood that the region of interest of the mobile device 110 can have a different radius. In other embodiments, the region of interest can correspond to an area around the mobile device 110 that has limited (or no) cellular service. Thus, in these embodiments, the region of interest may not necessarily be circular. For example, the region of interest can correspond to areas that are unable to facilitate the transmission of signals to cellular towers or the reception of signals from cellular towers. To illustrate, the region of interest can correspond to nearby forest areas, nearby desert areas, nearby caves, etc. In some embodiments, the region of interest of the mobile device 110 can be user configurable. For example, a user can set the region of interest using a user interface of the mobile device 110.

In FIG. 1, the mobile device 110 can be located in an area where there is no cellular coverage or in an area where there is limited cellular coverage. As a non-limiting example, as illustrated in FIG. 1, the mobile device 110 can be in a wooded area (e.g., a forest) that has limited (or no) cellular coverage. The mobile device 110 can correspond to a mobile phone, a laptop computer, a tablet computer, or a wearable computing device, among other possibilities. As described below, the mobile device 110 can use the satellite 102 to broadcast messages to nearby mobile devices 120. In particular, as described below, the mobile device 110 can send (e.g., initiate the broadcast of) one or more satellite datagrams 130 to the nearby mobile device 120 using the satellite 102.

As illustrated in FIG. 1, the plurality of nearby mobile devices 120 includes a mobile device 120A, a mobile device 120B, a mobile device 120C, a mobile device 120D, and a mobile device 120E. Although five (5) mobile devices 120 are depicted in FIG. 1, it should be understood that there can be additional or fewer nearby mobile devices 120. As a non-limiting example, the plurality of nearby mobile devices 120 can include thousands of mobile devices 120. As another non-limiting example, the plurality of nearby mobile devices 120 can include two mobile devices 120.

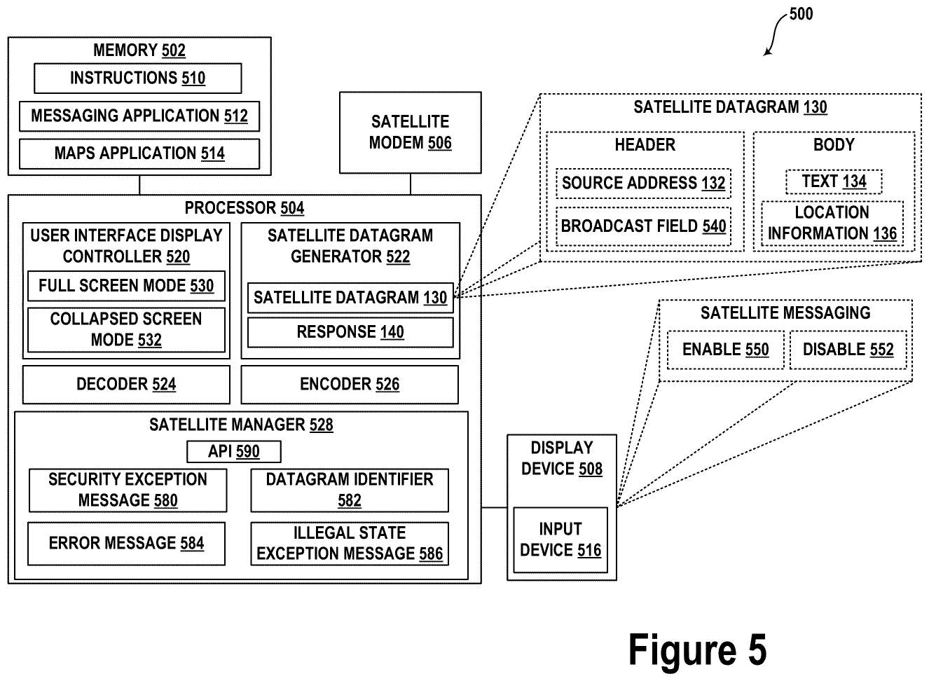

Each mobile device 120 can selectively enable reception of satellite-communicated datagrams, such as the satellite datagram 130. For example, each mobile device 120 can be configured to receive a user command that, when selected, activates a feature that enables the mobile device 120 to receive satellite messages. In some embodiments, selection of the user command can enable reception of satellite datagrams initiated by nearby mobile devices (e.g., the mobile device 110), reception of satellite alerting messages from a satellite service provider, reception of satellite alerting messages from an emergency service center, or a combination thereof. Activation of satellite messaging is described in further detail with respect to FIG. 5.

In the illustrative example of FIG. 1, the mobile devices 120A, 120D that are enclosed with the dashed ellipse have enabled reception of satellite-communicated datagrams, and the other mobile devices 120B, 120C, 120E have disabled reception of satellite-communicated datagrams. However, it should be understood that in other examples, reception of satellite-communicated datagrams can be enabled for a different group of the mobile devices 120. For example, in one example, reception of satellite-communicated datagrams can be enabled in all of the mobile devices 120. In another example, reception of satellite-communicated datagrams can be enabled for a single mobile device 120A.

To facilitate communication while the mobile device 110 is an area without cellular coverage, the mobile device 110 may be configured to broadcast a satellite message (e.g., the satellite datagram 130) to the nearby mobile devices 120 using the satellite 102. To illustrate, the mobile device 110 can be configured to generate the satellite datagram 130. The satellite datagram 130 can include text 134, location information 136, or both. For example, in some embodiments, the satellite datagram 130 can correspond to a text message. In these embodiments, the satellite datagram 130 can include text 134 from a messaging application executed by the mobile device 110. In other embodiments, the satellite datagram 130 can correspond to a location-sharing message. In these embodiments, the satellite datagram 130 can include the location information 136 from a maps application executed by the mobile device 110. The location information 136 can correspond to Global Navigation Satellite System (GNSS) coordinates of the mobile device 110, longitude and latitude coordinates of the mobile device 110, or other location parameters that indicate the location of the mobile device 110. In one embodiment, the GNSS coordinates of the mobile device 110 correspond to Global Positioning System (GPS) coordinates. In some scenarios, the location information 136 can include a Uniform Resource Locator (URL) that enables tracking of the location of the mobile device 110. Thus, the location information 136 can enable nearby mobile devices 120 to track the location of the mobile device 110.

The satellite datagram 130 can also include a source address 132 of the mobile device 110. For example, the mobile device 110 can populate a source address field in the satellite datagram 130 with the source address 132 of the mobile device 110. The source address 132 can correspond to a unique identifier of the mobile device 110. In one example, the source address 132 can correspond to an International Mobile Equipment Identity (IMEI) number of the mobile device 110. In another example, the source address 132 can correspond to an Internet Protocol (IP) address of the mobile device 110. As described below, the source address 132 can be used by one or more of the nearby mobile devices 120 to send data (e.g., a response 140) to the mobile device 110 via the satellite.

The mobile device 110 can be configured to initiate a broadcast of the satellite datagram 130 to nearby mobile devices 120 within the region of interest of the mobile device 110. As described above, the region of interest of the mobile device 110 can correspond to a coverage area of the satellite(s) 102 associated with the mobile device 110, an area around the mobile device 110 that has limited (or no) cellular service, etc. By broadcasting the satellite datagram 130 to nearby mobile devices 120 within the region of interest, as opposed to broadcasting the satellite datagram 130 to every possible mobile device, mobile devices 120 that are relatively proximate to the mobile device 110 can receive the satellite datagram 130. For example, it would not be practical to broadcast the satellite datagram 130 to a mobile device thousands of miles away from the mobile device 110, as a user thousands of miles away would not be able to help the user of the mobile device 110 in an emergency situation.

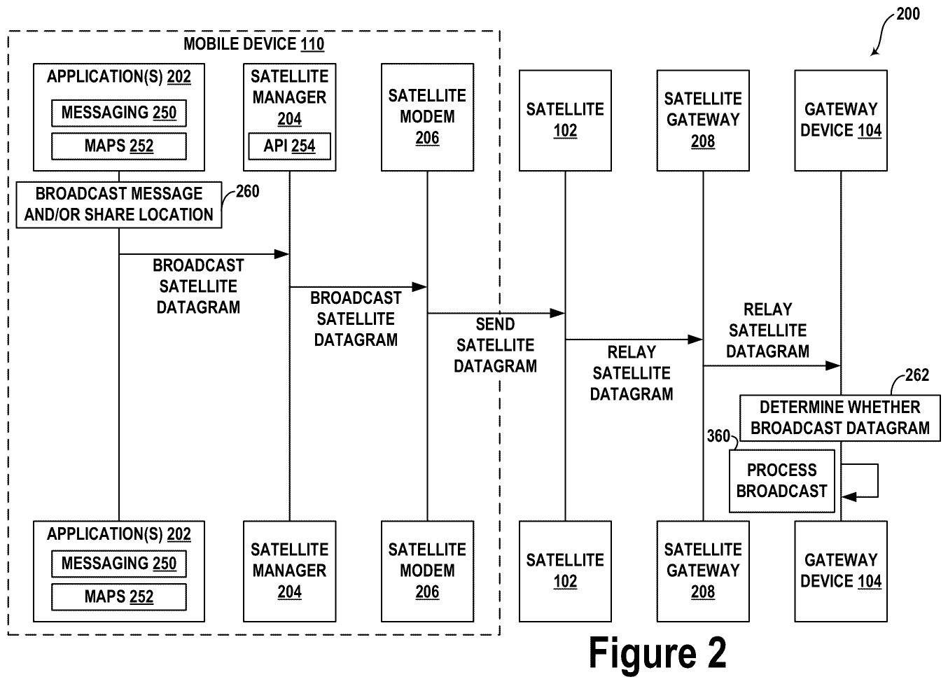

To initiate the broadcast of the satellite datagram 130, the mobile device 110 may populate a designated field in the header of the satellite datagram 130 to indicate that the satellite datagram 130 is to be broadcast. As a non-limiting example, a broadcast field in the header of the satellite datagram 130 can be populated with a binary one value to broadcast the satellite datagram 130. The mobile device 110 can transmit the satellite datagram 130 to the satellite 102, and the satellite 102 can transmit (e.g., relay) the satellite datagram 130 to the gateway device 104. As described with respect to FIG. 2, a satellite gateway 208 can serve to relay the satellite datagram 130 from the satellite 102 to the gateway device 104.

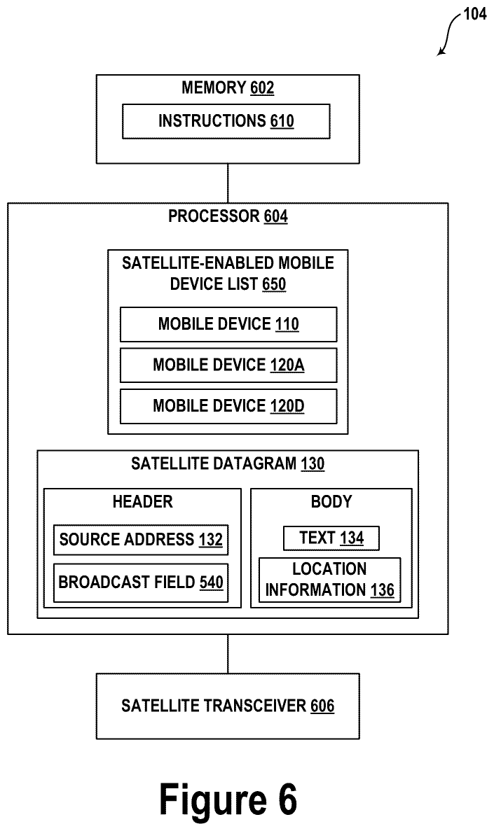

The gateway device 104 can be configured to receive the satellite datagram 130 from the satellite 102. As described in greater detail with respect to FIG. 6, the gateway device 104 can be configured to receive a list of nearby mobile devices 120A, 120D that have selected the option to enable reception of satellite-communicated datagrams. Based on the list, the gateway device 104 can forward the satellite datagram 130 to each nearby mobile device 120A, 120D in the list of nearby mobile devices via the satellite 102. Thus, the gateway device 104 can facilitate the broadcast of the satellite datagram 130) to the nearby mobile devices 120A, 120D that are included in the list. In some embodiments, the gateway device 104 can facilitate the broadcast of the satellite datagram 130 to each mobile device 120A-120E within a broadcast range of the satellite 102. In these embodiments, the mobile devices 120B, 120C, 120E that did not select the option to enable reception of satellite-communicated datagrams would not receive the broadcast from the gateway device 104.

The mobile devices 120A, 120D can be configured to receive the satellite datagram 130 from the gateway device 104 in response to enabling reception of satellite-communicated datagrams. For brevity of description, the below description is directed to the mobile device 120A. However, it should be understood that the operations performed by the mobile device 120A can be performed by any mobile device, such as the mobile device 120D, which has enabled reception of satellite-communicated datagrams.

The mobile device 120A can be configured to decode/decrypt the satellite datagram 130 to recover the text 134 and/or the location information 136 in the satellite datagram 130. A notification can be displayed at the mobile device 120A. The notification can include the text 134 and/or the location information 136. Additionally, the mobile device 120A can be configured to fetch, from the satellite datagram 130, the source address 132 of the mobile device 110. Fetching the source address 132 of the mobile device 110 can include parsing the header of the satellite datagram 130 to obtain the source address 132 of the mobile device 110. Based on the source address 132, the mobile device 120A can communicate with the mobile device 110 using the satellite 102. For example, the mobile device 120A can be configured to generate a response 140 (e.g., another satellite datagram) and send the response 140 to the mobile device 110.

In some examples, the mobile device 120A can send the response 140 to the mobile device 110 via the satellite 102. For example, the mobile device 120A can populate a destination field of the response 140 with the source address 132 of the mobile device 110 to send the response 140 to the mobile device 110 via the satellite 102. In other examples, the gateway device 104 can be used to forward the response 140 to the mobile device 110 using the satellite 102. In yet other examples, the mobile device 120A can determine a communication channel frequency of the mobile device 110 based on header data in the satellite datagram 130 and can send the response 140 directly to the mobile device 110 using the communication channel frequency. In each of the above examples, the mobile device 120A can send the response 140 using satellite messaging, as opposed to cellular communications, to facilitate communication with the mobile device 110 while the mobile device 110 is in an area without cellular coverage.

In examples where the satellite datagram 130 includes the location information 136, the mobile device 120 can be configured to fetch the location information 136 associated with the mobile device 110 from the satellite datagram 130. Based on the location information 136, the mobile device 120A can be configured to track the location of the mobile device 110. For example, the location information 136 can include GPS coordinates of the mobile device 110, longitude and latitude coordinates of the mobile device 110, or a URL that enables the mobile device 120A to dynamically track movements of the mobile device 110 and the location of the mobile device 110.

The system 100 of FIG. 1 enables the mobile device 110 to broadcast satellite messages to nearby mobile devices 120 while the mobile device 110 is in an area without cellular coverage. For example, by generating the satellite datagram 130 and broadcasting the satellite datagram 130 to nearby mobile devices 120 using the satellite messaging infrastructure (e.g., the satellite 102 and the gateway device 104), the mobile device 110 can communicate with nearby mobile devices 120 while the mobile device is in an area without cellular coverage.

Thus, in emergency situations, a user of the mobile device 110 can broadcast the satellite datagram 130 (e.g., a text message, a location-sharing message, or both) to nearby mobile devices 120 to request assistance. For example, by enabling the broadcast and reception of satellite messages (e.g., the satellite datagram 130 and the response 140), emergency messages 130 and responses 140 to emergency messages can be communicated in areas with limited cellular coverage. As a non-limiting example, if a particular user suffers an accident in an area with limited (or no) cellular coverage, the particular user may not be able to dial “911” to ask for assistance. However, according to the techniques described with respect to FIG. 1, the particular user can send a satellite message 130, requesting help, to other nearby mobile devices 120. Upon reception of the satellite message 130, users of the other nearby mobile devices 120 can (1) respond to the particular user (via satellite message), (2) track a location of the particular user, or both, to provide emergency assistance to the particular user. Thus, when the particular user is in a remote area where emergency services cannot respond quickly, the particular user can seek help from users of other nearby mobile devices 120 via satellite messaging.

FIG. 2 illustrates a process 200 for broadcasting satellite datagrams to nearby mobile devices using satellite messaging. For example, the process 200 illustrates operations for broadcasting the satellite datagram 130 of FIG. 1. The operations associated with the process 200 can be performed by the mobile device 110, the satellite 102, a satellite gateway 208, and the gateway device 104. The satellite gateway 208 can be an intermediate device that relays data between the gateway device 104 and the satellite 102. For example, the satellite gateway 208 can be a ground station that communicates data between the satellite 102 and the gateway device 104.

In FIG. 2, one or more applications 202 can be executed by a processor of the mobile device 110, and the mobile device 110 can include a satellite manager 204 and a satellite modulator-demodulator (modem) 206. The one or more applications 202 can include a messaging application 250 and a maps application 252. Using the one or more applications 202, the mobile device 110 can generate a text message, location-sharing message, or both, at block 260, for broadcast. For example, the messaging application 250 can generate a text message (e.g., the text 134) to broadcast to nearby mobile devices 120, and the maps application 252 can generate a location-sharing message (e.g., the location information 136) to broadcast to nearby mobile devices 120. The text message and/or the location-sharing message can be encoded into the satellite datagram 130 and provided to the satellite manager 204 for broadcast.

The satellite manager 204 can include an application programming interface (API) 254 that facilitates broadcasting the satellite datagram 130 to the surrounding mobile devices 120. In particular, the API 254 can perform telephony operations associated with broadcasting the satellite datagram 130. For example, the satellite manager 204 and/or the API 254 can provide the satellite datagram 130 to the satellite modem 206 without any further encryption or encoding, and the satellite modem 414 can send the satellite datagram 130 to a satellite, such as the satellite 102, for broadcast. The satellite manager 204 and/or the API 254 can call an executor to determine whether the satellite datagram 130 was successfully sent. If the satellite datagram 130 was successfully sent, a datagram identifier is returned. However, if the satellite datagram 130 was not successfully sent, an error message is returned.

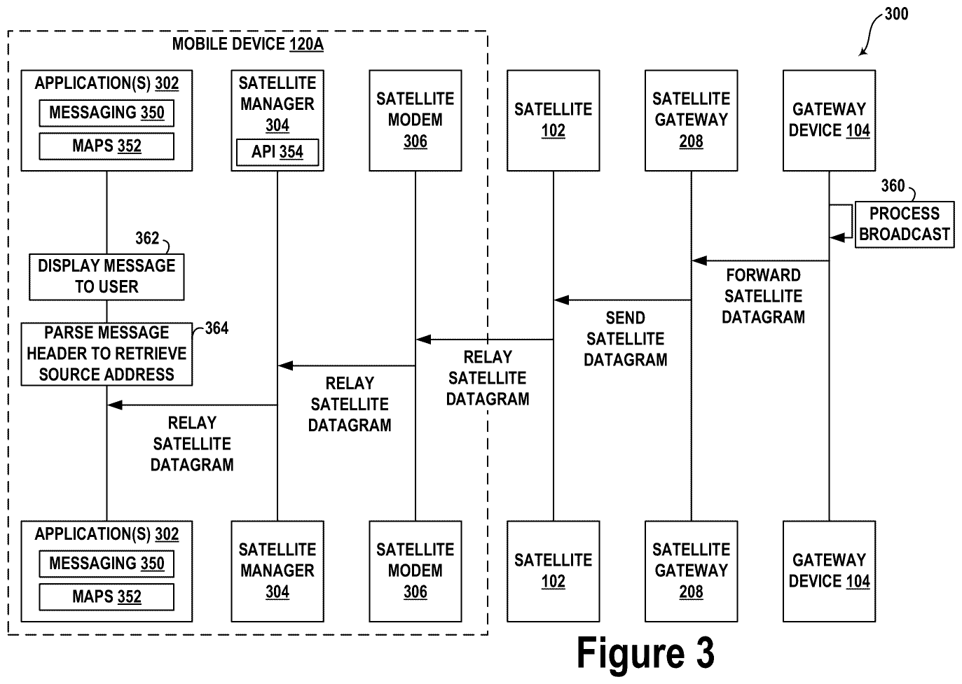

The satellite 102 can relay (e.g. forward) the satellite datagram 130 to the satellite gateway 208, and the satellite gateway 208 can relay (e.g., forward) the satellite datagram 130 to the gateway device 104. The gateway device 104 can be configured to determine whether the satellite datagram 130 is a broadcast datagram, at block 262. For example, the gateway device 104 can parse the header of the satellite datagram 130 to determine whether the broadcast field indicates the satellite datagram 130 is a broadcast datagram. In response to determining that the satellite datagram 130 is a broadcast datagram, the gateway device 104 can process the broadcast datagram (e.g., the satellite datagram 130), at block 360, as described in greater detail with respect to FIG. 3.

FIG. 3 illustrates a process 300 for broadcasting satellite datagrams to nearby mobile devices using satellite messaging. For example, the process 300 illustrates operations for broadcasting the satellite datagram 130 of FIG. 1. The operations associated with the process 300 can be performed by the mobile device 120A, the satellite 102, the satellite gateway 208, and the gateway device 104.

At block 360, the gateway device 104 can be configured to process the broadcast datagram (e.g., the satellite datagram 130). To process the satellite datagram 130, the gateway device 104 can query the surrounding mobile devices 120 to determine which mobile devices 120 have selected the option to enable reception of satellite-communicated datagrams. In response to identifying the mobile devices 120A, 120D that have selected the option, the gateway device 104 can forward the satellite datagram 130 to each nearby mobile device 120A, 120D. For ease of description and illustration, FIG. 3 depicts the process 300 for forwarding the satellite datagram 130 to the mobile device 120A. However, it should be understood that similar operations can be performed to forward the satellite datagram 130 to other mobile devices that have selected the option to enable reception of satellite-communicated datagrams, such as the mobile device 120D. The gateway device 104 can forward the satellite datagram 130 to the satellite gateway 208, and the satellite gateway 208 can send the satellite datagram 130 to the satellite 102. The satellite 102 can relay (e.g., forward) the satellite datagram 130 to the mobile device 120A.

One or more applications 302 can be executed by a processor of the mobile device 120A, and the mobile device 120A can include a satellite manager 304 and a satellite modem 306. The satellite modem 306 can receive the satellite datagram 130 and relay (e.g., forward) the satellite datagram 130 to satellite manager 304. The satellite manager 304 includes an API 354 to facilitate reception and processing of the broadcast datagrams. In particular, the API 354 can call an executor to determine whether the satellite datagram 130 was successfully sent. If the satellite datagram 130 was successfully sent, a datagram identifier is returned. However, if the satellite datagram 130 was not successfully sent, an error message is returned. In some scenarios, the telephony process associated with the satellite manager 304 and/or the API 354 may not be available. In these scenarios, an illegal state exception message is returned. The satellite manager 304 can forward the satellite datagram 130 to the one or more applications 302.

The one or more applications 302 can include a messaging application 350 and a maps application 352. Using the one or more applications 302 (e.g., the messaging application 350), the mobile device 110 can display the text message (e.g., the text 134) associated with the satellite datagram 130, at block 262, if the satellite datagram 130 corresponds to a text message. Alternatively, or in addition, using the one or more applications 302 (e.g., the maps application 352), the mobile device 110 can display and track a location of the mobile device 110, at block 362, if the satellite datagram 130 is a location-sharing message.

Additionally, at block 364, the satellite manager 304 or the one or more applications can be configured to parse a message header of the satellite datagram 106 to determine the source address 132 of the mobile device 110. Based on the source address 132, the mobile device 120A can communicate with the mobile device 110 using the satellite 102. For example, the mobile device 120A can be configured to generate the response 140 (e.g., another satellite datagram) and send the response 140 to the mobile device 110 via the satellite 102.

The techniques described with respect to FIGS. 2-3 enable the mobile device 110 to broadcast satellite messages to mobile devices 120A while the mobile device 110 is in an area without cellular coverage. For example, by generating the satellite datagram 130 and broadcasting the satellite datagram 130 to the mobile devices 120A using the satellite messaging infrastructure (e.g., the satellite 102, the satellite gateway 208, and the gateway device 104), the mobile device 110 can communicate with the nearby mobile device 120A while the mobile device is in an area without cellular coverage. Thus, in emergency situations, a user of the mobile device 110 can broadcast the satellite datagram 130 (e.g., a text message, a location-sharing message, or both) to the nearby mobile device 120A to request assistance.

### Example Mobile Device Configurations for Satellite Messaging

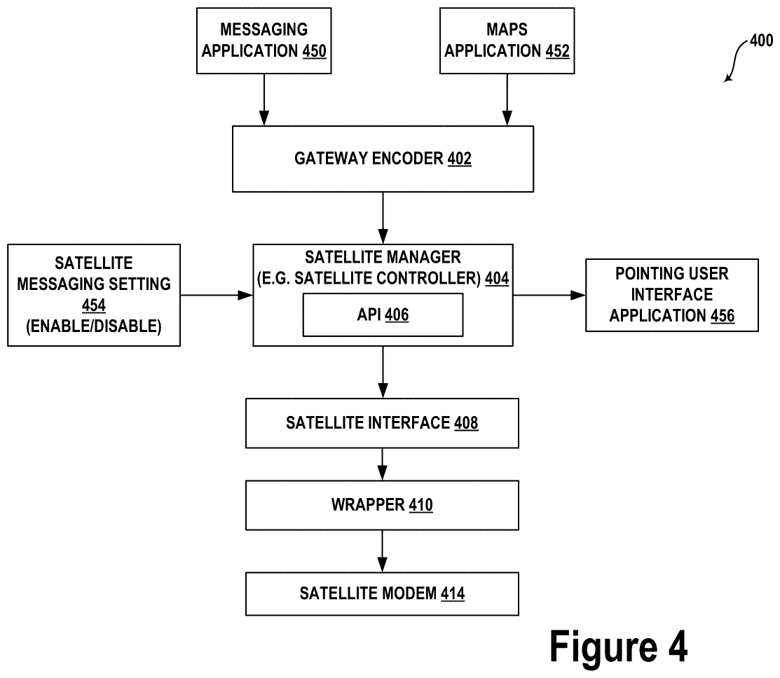

FIG. 4 illustrates a device configuration 400 for a mobile device that can broadcast satellite datagrams and receive broadcast satellite datagrams. In FIG. 4, the device configuration 400 includes a gateway encoder 402, a satellite manager 404, a satellite interface 408, a wrapper 410, and a satellite modem 414. The device configuration 400 can be integrated into the mobile device 110 or into any of the mobile devices 120. As a non-limiting example, in a scenario where the device configuration 400 is integrated into the mobile device 110, the satellite manager 404 can correspond to the satellite manager 204 of FIG. 2, the API 406 can correspond to the API 254 of FIG. 2, and the satellite modem 414 can correspond to the satellite modem 206 of FIG. 2. In a scenario where the device configuration 400 is integrated into the mobile device 120A, the satellite manager 404 can correspond to the satellite manager 304 of FIG. 3, the API 406 can correspond to the API 354 of FIG. 3, and the satellite modem 414 can correspond to the satellite modem 306 of FIG. 3.

The gateway encoder 402 can be configured to encode a text message, from a messaging application 450, to be broadcast in a satellite datagram, such as the satellite datagram 130. For example, the messaging application 450 can generate the text 134 in the satellite datagram 130, and the gateway encoder 402 can encode the text 134 prior to broadcasting the satellite datagram 130. Additionally, or in the alternative, the gateway encoder 402 can be configured to encode a location-sharing message, from a maps application 452, to be broadcast in a satellite datagram, such as the satellite datagram 130. For example, the maps application 452 can generate the location information 136 associated with the mobile device 110, and the gateway encoder 402 can encode the location information 136 prior to broadcasting the satellite datagram 130.

The satellite manager 404 (e.g., a satellite controller) includes, or is part of, an API 254 that facilitates sending broadcast datagrams to the surrounding mobile devices 120 and receiving broadcast datagrams from surrounding mobile devices. The satellite manager 404 and/or the API 406 can be configured to receive a user command to enable the broadcast and reception of satellite-communicated datagrams. For example, a satellite messaging setting 454 can be selectively enabled or disabled by a user. In response to user enablement of the satellite messaging setting 454, the satellite manager 404 and/or the API 406 can facilitate the broadcast and reception of satellite datagrams, such as the satellite datagram 130. However, if the satellite manager 404 and/or the API 406 does not have the required permission to broadcast satellite datagrams (e.g., the satellite messaging setting 454 is disabled), a security exception message is returned by the API 406.

The satellite manager 404 and/or the API 406 can provide the satellite datagram 130 to satellite modem 414 via the satellite interface 408 and the wrapper 410. The satellite datagram 130 can be passed down from the satellite manager 404 to the satellite modem 414 without any further encryption or encoding. For example, after the gateway encoder 402 encodes the text 134 and/or the location information 136 into the satellite datagram 130, the satellite manager 404 can populate different fields in the header of the satellite datagram 130 (e.g., populate the broadcast field and the source address field) without performing additional encoding operations. The satellite modem 414 can send the satellite datagram 130 to a satellite, such as the satellite 102, for broadcast.

The satellite manager 404 and/or the API 406 can call an executor to determine whether the satellite datagram 130 was successfully sent. If the satellite datagram 130 was successfully sent, a datagram identifier is returned. However, if the satellite datagram 130 was not successfully sent, an error message is returned. In some scenarios, the telephony process associated with the satellite manager 404 and/or the API 406 may not be available. In these scenarios, an illegal state exception message is returned.

The returned messages from the satellite manager 404 and/or the API 406 can be presented using a pointing user interface application 456. The pointing user interface application 456 can be presented in a full screen mode or a collapsed screen mode. If satellite messaging has not previously been used, or a particular period of time has elapsed since satellite messaging has been used, the pointing user interface application 456 can be presented in the full screen mode. Otherwise, the pointing user interface application 456 can be presented in the collapsed screen mode.

The device configuration 400 described with respect to FIG. 4 enables a mobile device, such as the mobile device 110, to broadcast satellite messages to nearby mobile devices while the mobile device is in an area without cellular coverage. For example, by generating a satellite datagram and broadcasting the satellite datagram to nearby mobile devices using the device configuration, the mobile device can communicate with nearby mobile devices while the mobile device is in an area without cellular coverage. Thus, in emergency situations, a user of the mobile device can broadcast the satellite datagram (e.g., a text message, a location-sharing message, or both) to nearby mobile devices to request assistance.

FIG. 5 illustrates a mobile device 500 that is operable to broadcast satellite messages to nearby mobile devices and operable to receive broadcast satellite messages from nearby mobile devices. The mobile device 500 can correspond to the mobile device 110 or any of the mobile devices 120. According to some examples, the mobile device 500 can perform the functions described with respect to the device configuration 400.

The mobile device 500 includes a memory 502, a processor 504 coupled to the memory 502, a satellite modem 506 coupled to the processor 504, and a display device 508 coupled to the processor 504. The satellite modem 506 can correspond to the satellite modem 206 of FIG. 2, the satellite modem 306 of FIG. 3, or satellite modem 414 of FIG. 4.

The memory 502 can correspond to a non-transitory computer-readable medium that includes instructions 510 executable by the processor 504 to perform the operations described herein. The processor 504 includes a user interface display controller 520, a satellite datagram generator 522, a decoder 524, an encoder 526, and a satellite manager 528. The satellite manager 528 can correspond to the satellite manager 204 of FIG. 2, the satellite manager 304 of FIG. 3, or the satellite manager 404 of FIG. 4.

The display device 508 can be configured to present a user of the mobile device 500 with an option to selectively enable satellite messaging (e.g., enable broadcast of satellite datagrams and reception of broadcasted satellite datagrams). For example, the processor 504 can generate a user interface that is presented on the display device 508. The user of the mobile device 500 can use the display device 508 as an input device 516 to enable 550 satellite messaging or disable 552 satellite messaging. For example, the input device 516 can correspond to touchscreen functionality on the display device 508 that enables a user to enable 550 satellite messaging by touching a particular portion of the display device 508 or disable 552 satellite messaging by touching another particular portion of the display device 508. By selecting the option to enable 550 satellite messaging, a user command can be sent to the processor 504 that activates a feature that enables the mobile device 500 to broadcast satellite messages and receive broadcasted satellite messages.

The satellite datagram generator 522 can be configured to generate the satellite datagram 130 based on the text 134 generated using a messaging application 512 and/or based on the location information 136 generated using a maps application 514. For example, the memory 502 can store instructions/data associated with the messaging application 512 and instructions/data associated with the maps application 514. The processor 504 can execute applications 512, 514 to generate the text 134 and the location information 136, respectively. The messaging application 512 can correspond to the messaging application 250 of FIG. 2, the messaging application 350 of FIG. 3, or the messaging application 450 of FIG. 4, and can be used to generate text, such as the text 134. The maps application 514 can correspond to the maps application 252 of FIG. 2, the maps application 352 of FIG. 3, or maps application 452 of FIG. 4, and can be used to generate location information, such as the location information 136. The satellite datagram generator 522 can add the text 134 and/or the location information 136 to a body of the satellite datagram 130.

Additionally, in some scenarios, the satellite datagram generator 522 can be configured to populate a source field in a header of the satellite datagram 130 with the source address 132 of the mobile device 500. The source address 132 can correspond to a unique identifier of the mobile device 500 and can be usable by nearby mobile devices to send responses to the mobile device 500. To ensure that the satellite datagram 130 is broadcast, in some scenarios, the satellite datagram generator 522 can also be configured to a broadcast field 540 in the header of the satellite datagram 130 to indicate that the satellite datagram 130 is to be broadcast. As a non-limiting example, the broadcast field 540 in the header of the satellite datagram 130 can be populated with a binary one value to broadcast the satellite datagram 130. The encoder 526 can be configured to encode the satellite datagram 130 prior broadcast of the satellite datagram 130) (e.g., prior to the satellite manager 528 initiating broadcast of the satellite datagram 130).

The satellite manager 528 includes, or is part of, an API 590 that facilitates sending broadcast datagrams to the surrounding mobile devices and receiving broadcast datagrams from surrounding mobile devices. The satellite manager 528 and/or the API 590 can be configured to receive the user command that indicates satellite messaging has been enabled 550). In response to user enablement of the satellite messaging setting, the satellite manager 528 and/or the API 590) can facilitate the broadcast and reception of satellite datagrams, such as the satellite datagram 130. However, if the satellite manager 528 and/or the API 590 does not have the required permission to broadcast satellite datagrams, a security exception message 580 is returned by the API 590 if the user attempts to broadcast the satellite datagram 130.

The satellite manager 528 and/or the API 590 can provide the satellite datagram 130 to the satellite modem 506 without any further encryption or encoding. The satellite modem 414 can send the satellite datagram 130 to a satellite, such as the satellite 102, for broadcast. The satellite manager 528 and/or the API 590 can call an executor to determine whether the satellite datagram 130 was successfully sent. If the satellite datagram 130 was successfully sent, a datagram identifier 582 is returned. However, if the satellite datagram 130 was not successfully sent, an error message 584 is returned. In some scenarios, the telephony process associated with the satellite manager 528 and/or the API 590 may not be available. In these scenarios, an illegal state exception message 586 is returned.

The user interface display controller 520 can be configured to determine how to display the messages from the satellite manager 528 and/or the API 590. For example, a satellite messaging user interface application that displays the messages can be displayed in a full screen mode 530 or a collapsed screen mode 532. If the user interface display controller 520) determines that satellite messaging has not previously been used by the mobile device 500, or a particular period of time has elapsed since the mobile device 500 utilized satellite messaging, the satellite messaging user interface application can be presented in the full screen mode 530. Thus, if the user of the mobile device 500 is sending data (e.g., a satellite datagram) for a first time via satellite messaging, the user interface display controller 520 can present the satellite messaging user interface application in the full screen mode 530 to enhance the user experience. Otherwise, the user interface display controller 520 can present the satellite messaging user interface application in the collapsed screen mode 532.

The mobile device 500 described with respect to FIG. 5 enables the broadcasting of satellite messages to nearby mobile devices while the mobile device 500 is in an area without cellular coverage. For example, by generating the satellite datagram 130 and broadcasting the satellite datagram 130 to nearby mobile devices using the satellite messaging infrastructure (e.g., the satellite datagram generator 522, the satellite manager 528, the API 590, and the satellite modem 506), the mobile device 500 can communicate with nearby mobile devices while the mobile device is in an area without cellular coverage. Thus, in emergency situations, a user of the mobile device 500 can broadcast the satellite datagram 130 (e.g., a text message, a location-sharing message, or both) to nearby mobile devices to request assistance.

### Example Gateway Device

FIG. 6 illustrates the gateway device 104 that is operable to forward broadcast satellite datagrams to nearby devices. The gateway device 104 includes a memory 602, a processor 604 coupled to the memory 602, and a satellite transceiver 606 coupled to the processor 604. The memory 602 can correspond to a non-transitory computer-readable medium that includes instructions 610 executable by the processor 604 to perform the operations described herein. Although a satellite transceiver 606 is illustrated, in some implementations, the gateway device 104 can include a receiver and a transmitter.

The satellite transceiver 606 can be configured to receive a satellite-enabled mobile device list 650. The satellite-enabled mobile device list 650 can correspond to a list of nearby mobile devices that have selected an option to enable reception of satellite-communicated datagrams. For example, if a user selects to enable 550 satellite messaging using the input device 516 of FIG. 5, the mobile device 500 would be included in the satellite-enabled mobile device list 650. In the illustrative examples described herein, the satellite-enabled mobile device list 650 includes the mobile device 110, the mobile device 120A, and the mobile device 120D. According to some embodiments, the gateway device 104 can receive this list by polling each nearby mobile device 110, 120 to determine whether to the option to enable reception of satellite-communicated datagrams.

The satellite transceiver 606 can also be configured to receive the satellite datagram 130 from the satellite 102 and forward the satellite datagram 130 to each nearby mobile device 120A, 120D in the satellite-enabled mobile device list 650. Thus, the gateway device 104 can enable broadcast datagrams from the broadcasting mobile device 110 to reach nearby mobile devices 120A, 120D that have enabled reception of satellite-communicated datagrams.

### Example Methods of Operation

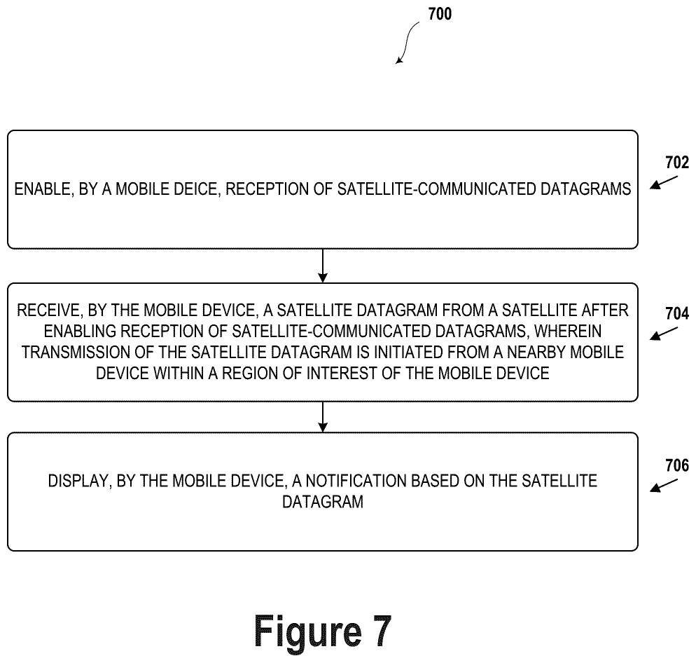

FIG. 7 is a flowchart of a method 700, in accordance with example embodiments. The method 700 can be performed by a mobile device, such as the mobile device 110 or any of the mobile devices 120.

The method 700 includes enabling, by a mobile device, reception of satellite-communicated datagrams, at block 702. For example, referring to FIG. 1, the mobile device 120A can receive a user command to enable reception of satellite-communicated datagrams, such as the satellite datagram 130.

The method 700 also includes receiving, by the mobile device, a satellite datagram from a satellite after enabling reception of satellite-communicated datagrams, at block 704. Transmission of the satellite datagram is initiated from a nearby mobile device within a region of interest of the mobile device. For example, referring to FIG. 1, the mobile device 120A can receive the satellite datagram 130 from the satellite 102 in response to enabling reception of satellite-communicated datagrams. Transmission of the satellite datagram 130 is initiated from the mobile device 110.

The method 700 also includes displaying, by the mobile device, a notification based on the satellite datagram, at block 706. For example, a notification can be displayed at the mobile device 120A. The notification can include the text 134 and/or the location information 136.

According to one embodiment, the method 700 also includes fetching, by the mobile device and from the satellite datagram, a source address of the nearby mobile device. For example, referring to FIG. 1, the mobile device 120A can fetch the source address 132 of the mobile device 110 from the satellite datagram 130. Fetching the source address 132 of the nearby mobile device 110 can include parsing the header of the satellite datagram 130 to obtain the source address 132.

According to one embodiment, the method 700 also includes communicating with the nearby mobile device based on the source address. For example, referring to FIG. 1, the mobile device 120A may use the source address 132 of the mobile device 110 to send additional satellite datagrams (e.g., the response 140) to the mobile device 110 through the satellite 102. Communicating with the nearby mobile device 110 can include sending one or more additional satellite datagrams (e.g., the response 140) to the nearby mobile device 110.

According to one embodiment of the method 700, the satellite datagram 130 corresponds to a text message. According to another embodiment of the method 700, the satellite datagram 130 corresponds to a location-sharing message. In this embodiment, the method 700 can also include fetching, by the mobile device 120A and from the satellite datagram 130, location information 136 associated with the nearby mobile device 110 and tracking the location of the nearby mobile device 110 based on the location information 136.

The method 700 enables the mobile device 110 to broadcast satellite messages to nearby mobile devices 120 while the mobile device 110 is in an area without cellular coverage. For example, by generating the satellite datagram 130 and broadcasting the satellite datagram 130 to nearby mobile devices 120 using the satellite messaging infrastructure (e.g., the satellite 102 and the gateway device 104), the mobile device 110 can communicate with nearby mobile devices 120 while the mobile device is in an area without cellular coverage. Thus, in emergency situations, a user of the mobile device 110 can broadcast the satellite datagram 130 (e.g., a text message, a location-sharing message, or both) to nearby mobile devices 120 to request assistance.

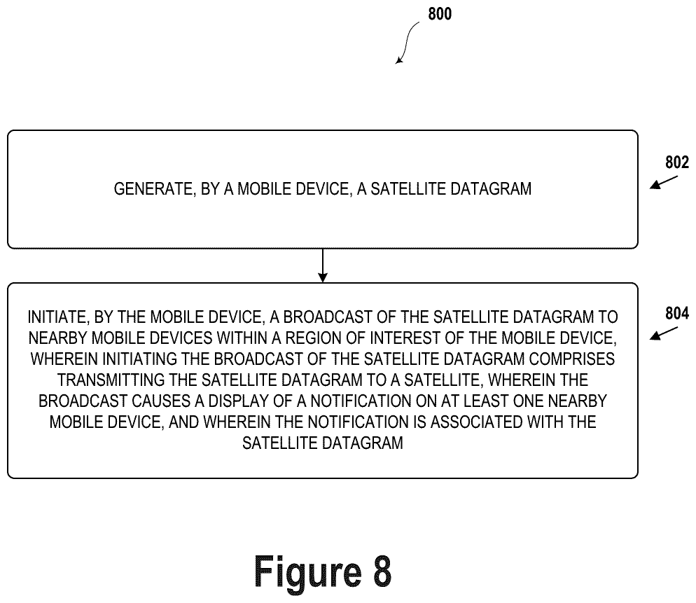

FIG. 8 is a flowchart of another method 800, in accordance with example embodiments. The method 800 can be performed by a mobile device, such as the mobile device 110 or any of the mobile devices 120.

The method 800 includes generating, by a mobile device, a satellite datagram, at block 802. For example, referring to FIG. 1, the mobile device 110 can generate the satellite datagram 130. The satellite datagram 130 includes the source address 132 of the mobile device 110.

The method 800 also includes initiating, by the mobile device, a broadcast of the satellite datagram to nearby mobile devices within a region of interest of the mobile device, at block 804. Initiating the broadcast of the satellite datagram includes transmitting the satellite datagram to a satellite. The broadcast causes a display of a notification on at least one nearby mobile device. The notification is associated with the satellite datagram. For example, referring to FIG. 1, the mobile device 110 can initiate the broadcast of the satellite datagram 130 to the nearby mobile devices 120 by transmitting the satellite datagram 130 to the satellite 102. A notification can be displayed at the mobile device 120A. The notification can include the text 134 and/or the location information 136.

According to one embodiment, the method 800 also includes receiving, by the mobile device, a response to the satellite datagram from a particular nearby mobile device. The response is generated in response to fetching the source address of the mobile device from the satellite datagram. For example, referring to FIG. 1, the mobile device 110 can receive the response 140 to the satellite datagram 130 from the mobile device 120A. The response 140 can be generated in response to the mobile device 120A fetching the source address 132 of the mobile device 110 from the satellite datagram 130.

The method 800 enables the mobile device 110 to communicate with other nearby mobile devices 120 while the mobile device 110 is in an area without cellular coverage. For example, by generating satellite datagrams 130 and broadcasting the satellite datagrams 130 to nearby mobile devices 120 using satellite messaging, the mobile device 110 can communicate with nearby mobile devices 120 while the mobile device is in an area without cellular coverage. Thus, in emergency situations, a user of the mobile device 110 can broadcast the satellite datagram 130 (e.g., a text message, a location-sharing message, or both) to nearby mobile devices 120 to request assistance.

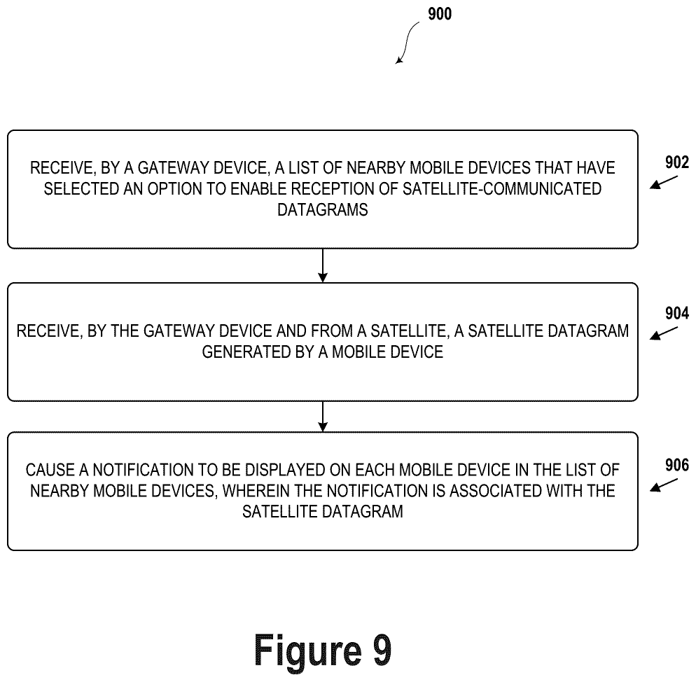

FIG. 9 is a flowchart of another method 900, in accordance with example embodiments. The method 900 can be performed by a gateway device, such as the gateway device 104.

The method 900 includes receiving, by a gateway device, a list of nearby mobile devices that have selected an option to enable reception of satellite-communicated datagrams, at block 902. For example, referring to FIG. 1, the gateway device 104 can receive a list of nearby mobile devices 120A, 120D that have selected the option to enable reception of satellite-communicated datagrams.

The method 900 also includes receiving, by the gateway device and from a satellite, a satellite datagram generated by a mobile device, at block 904. The satellite datagram includes a source address of the mobile device. For example, referring to FIG. 1, the gateway device 104 can receive the satellite datagram 130 from the satellite 102.

The method 900 also includes causing a notification to be displayed on each mobile device in the list of nearby mobile devices, at block 906. The notification is associated with the satellite datagram. For example, a notification can be displayed at the mobile device 120A. The notification can include the text 134 and/or the location information 136.

To cause the notification to be displayed at each mobile device in the list of mobile devices, the method 900 can include forwarding the satellite datagram to each nearby mobile device in the list of nearby mobile devices. Forwarding the satellite datagram also enables a particular nearby mobile device in the list of nearby mobile devices to respond to the satellite datagram by fetching the source address of the mobile device from the satellite datagram. For example, referring to FIG. 1, the gateway device 104 can forward the satellite datagram 130 to each nearby mobile device 120A, 120D in the list of nearby mobile devices. Forwarding the satellite datagram 130 enables the mobile device 120A to respond to the satellite datagram 130 by fetching the source address 132 of the mobile device 110 from the satellite datagram 130.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

With respect to embodiments that include determining a non-common term based on user interaction with a computing device, and/or determining alternative terms using a machine learning model, or interactions by the computing device with cloud-based servers, a user may be provided with controls allowing the user to make an election as to both if and when systems, programs, or features described herein may enable collection of user information (e.g., information about a user's social network, social actions, or activities, profession, a user's preferences, a user's demographic information, a user's current location, or other personal information), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

What is claimed is:

1. A computer-implemented method comprising:
enabling, by a mobile device, reception of satellite-communicated datagrams:
receiving, by the mobile device, a satellite datagram from a satellite after enabling reception of satellite-communicated datagrams, wherein transmission of the satellite datagram is initiated from a nearby mobile device within a region of interest of the mobile device; and
displaying, by the mobile device, a notification based on the satellite datagram.

2. The computer-implemented method of claim 1, wherein the satellite datagram corresponds to a text message.

3. The computer-implemented method of claim 1, wherein the satellite datagram corresponds to a location-sharing message, and further comprising:
fetching, by the mobile device and from the satellite datagram, location information associated with the nearby mobile device; and
tracking, by the mobile device, a location of the nearby mobile device based on the location information.

4. The computer-implemented method of claim 1, wherein the region of interest corresponds to an area proximate to the mobile device with limited cellular service.

5. The computer-implemented method of claim 4, wherein the satellite datagram is forwarded to the mobile device, from a gateway device, in response to a broadcast field of the satellite datagram indicating that that the satellite datagram is a broadcast satellite datagram.

6. The computer-implemented method of claim 1, further comprising:
fetching, by the mobile device and from the satellite datagram, a source address of the nearby mobile device; and
communicating with the nearby mobile device based on the source address.

7. The computer-implemented method of claim 6, wherein fetching the source address of the nearby mobile device comprises parsing a header of the satellite datagram to obtain the source address of the nearby mobile device.

8. The computer-implemented method of claim 6, wherein communicating with the nearby mobile device comprises communicating with the nearby mobile device through the satellite.

9. The computer-implemented method of claim 6, wherein communicating with the nearby mobile device comprises sending one or more additional satellite datagrams to the nearby mobile device.

10. The computer-implemented method of claim 1, further comprising receiving, by the mobile device, a user command to enable reception of satellite-communicated datagrams.

11. The computer-implemented method of claim 10, further comprising, prior to receiving the user command, generating a user interface that enables selection of the user command.

12. The computer-implemented method of claim 11, wherein the selection of the user command enables reception of satellite datagrams initiated by nearby mobile devices, reception of satellite alerting messages from a satellite service provider, reception of satellite alerting messages from an emergency service center, or a combination thereof.

13. A computer-implemented method comprising:
generating, by a mobile device, a satellite datagram; and
initiating, by the mobile device, a broadcast of the satellite datagram to nearby mobile devices within a region of interest of the mobile device, wherein initiating the broadcast of the satellite datagram comprises transmitting the satellite datagram to a satellite, wherein the broadcast causes a display of a notification on at least one nearby mobile device, and wherein the notification is associated with the satellite datagram.

14. The computer-implemented method of claim 13, wherein the satellite datagram includes a source address of the mobile device, and further comprising receiving a response to the satellite datagram from a particular nearby mobile device, wherein the response is generated in response to fetching the source address of the mobile device from the satellite datagram.

15. The computer-implemented method of claim 14, wherein the response to the satellite datagram is received via the satellite.

16. The computer-implemented method of claim 13, wherein the satellite datagram corresponds to a text message.

17. The computer-implemented method of claim 13, wherein the satellite datagram corresponds to a location-sharing message that comprises location information associated with the mobile device that enables the at least one nearby mobile device to track a location of the mobile device.

18. The computer-implemented method of claim 13, wherein initiating the broadcast of the satellite datagram further comprises populating a broadcast field in a header of the satellite datagram to indicate that satellite datagram is a broadcast datagram.

19. A mobile device comprising:
a memory; and
a processor coupled to the memory, the processor configured to:
enable reception of satellite-communicated datagrams:
receive a satellite datagram from a satellite after enabling reception of satellite-communicated datagrams, wherein transmission of the satellite datagram is initiated from a nearby mobile device within a region of interest of the mobile device; and
display a notification based on the satellite datagram.

20. The mobile device of claim 19, wherein the satellite datagram corresponds to a text message.
